(19) United States
(12) Patent Application Publication
(10) Pub. No.: US 2024/0240926 A1
(43) Pub. Date: Jul. 18, 2024

(54) MEASURING SYSTEM AND MEASUREMENT METHOD

(71) Applicant: MITUTOYO CORPORATION, Kanagawa (JP)

(72) Inventor: Kazuhiko HIDAKA, Tokyo (JP)

(73) Assignee: MITUTOYO CORPORATION, Kanagawa (JP)

(21) Appl. No.: 18/411,271

(22) Filed: Jan. 12, 2024

(30) Foreign Application Priority Data
Jan. 13, 2023 (JP) 2023-003619

(51) Int. Cl. G01B 5/016; G01B 21/04

(52) U.S. Cl. CPC G01B 5/016; G01B 21/042

(57) ABSTRACT

A measuring system includes: a measuring machine; a plurality of candidate probes attachable to the measuring machine; a selected probe selected from the candidate probes and attached to the measuring machine; and a control device configured to control the measuring machine to perform a measurement operation for a workpiece, the control device including: a calibration value recorder configured to record respective calibration values of the candidate probes with respect to the measuring machine; and a calibration value processor configured to acquire one of the calibration values corresponding to the selected probe from the calibration value recorder.

### CROSS REFERENCE TO RELATED APPLICATIONS

The entire disclosure of Japanese Patent Application No. 2023-003619 filed Jan. 13, 2023 is expressly incorporated by reference herein.

### TECHNICAL FIELD

The present invention relates to a measuring system and a measurement method with a probe-interchangeable measuring machine.

### BACKGROUND ART

In the field of measurement such as position measurement and form measurement, a measuring system and a measurement method with a probe-interchangeable measuring machine are often used. For instance, a coordinate measuring machine is often used to measure form and dimension of a workpiece and a contact probe attachable to the coordinate measuring machine is suitably selected depending on the form of the workpiece and a measurement content.

A calibration operation is applied to a probe attached to a measuring machine prior to measurement. For instance, a reference sphere (a master ball) is mounted on a table of a coordinate measuring machine, the coordinate measuring machine is operated to bring the probe into contact with a plurality of points on the reference sphere, measures a slight error of each probe with respect to the measuring machine, and records the error as a calibration value. During measurement, it is possible to obtain an error-corrected measurement value with reference to the calibration value (see Patent Literature 1 (JP 2014-85162 A) and the like).

The calibration operation as described above needs to be performed every time when a probe is attached to the measuring machine. In other words, when a probe is replaced, the probe needs to be repeatedly brought into contact with the reference sphere for a plurality of times by causing the measuring machine to operate, which requires working time and adversely affects an improvement in working efficiency.

### SUMMARY OF THE INVENTION

An object of the invention is to provide a measuring system and a measurement method that make it possible to quickly perform a measurement operation even with a probe-interchangeable measuring machine.

A measuring system according to an aspect of the invention includes: a measuring machine; a plurality of candidate probes attachable to the measuring machine; a selected probe selected from the candidate probes and attached to the measuring machine; and a control device configured to control the measuring machine to perform a measurement operation for a workpiece, the control device including: a calibration value recorder configured to record respective calibration values of the candidate probes with respect to the measuring machine; and a calibration value processor configured to acquire one of the calibration values corresponding to the selected probe from the calibration value recorder.

In the above aspect of the invention, prior to the measurement operation, a calibration value of each of the plurality of candidate probes when attached to the measuring machine is measured and recorded in the calibration value recorder. For the measurement operation, a suitable probe for the measurement of the workpiece is selected as the selected probe from the plurality of candidate probes and is attached to the measuring machine. In the control device, the calibration value corresponding to the selected probe is read from the calibration value recorder by the calibration value processor and used as the calibration value of the selected probe for the measurement operation.

As seen from the above, the calibration values of the plurality of candidate probes are measured and recorded in advance in the aspect of the invention, which makes it possible to acquire the calibration value corresponding to the selected probe at the time of the measurement operation; therefore, it is not necessary to perform the calibration operation for each measurement operation and a measurement operation is allowed to be quickly performed even with the probe-interchangeable measuring machine.

In the measuring system according to the aspect of the invention, the calibration value recorder may be located in an internal storage device of the control device or an external storage device that is connected to the control device and is able to communicate with the control device, the calibration value recorder recording the plurality of respective calibration values corresponding to the plurality of candidate probes.

In the above aspect of the invention, it is possible to set the calibration value recorder by securely arranging the internal storage device of the control device or the external storage device that is able to communicate with the control device. Moreover, no machining or the like of the candidate probes and the measuring machine is required. Further, it is possible to collectively record the calibration values of the plurality of candidate probes in the calibration value recorder, which facilitates a maintenance work such as data backup. In particular, in a case where the calibration value recorder is set in the external storage device that is able to communicate with the control device, it is possible to still use the calibration value recorder on an external recording region even when the control device is changed.

In the measuring system according to the aspect of the invention, the calibration value recorder may be located in each of the candidate probes, the calibration value recorder recording the calibration value of each of the candidate probes.

In the above aspect of the invention, a wire-communication or wireless-communication reading means is installed in or near the measuring machine, which makes it possible to read the calibration value of the candidate probe selected as the selected probe and loaded to the control device in use. Further, the calibration value is caused to accompany the candidate probe, which makes it possible to secure the correspondence between the calibration value and the candidate probe. Additionally, in a case where a calibration value with respect to a reference measuring machine is to be recorded as described later, the calibration value may be measured using another measuring machine.

In the measuring system according to the aspect of the invention, it is possible to acquire the calibration values using a reference sphere mounted in the measuring machine.

In the above aspect of the invention, use of a typical reference sphere in the measuring machine makes it possible to acquire the calibration values of the plurality of candidate probes easily and with a sufficient calibration accuracy.

In the above aspect of the invention, the calibration values may be values given by a calculation from respective measuring machine calibration values set for a plurality of measuring machines including the measuring machine and respective probe calibration values set for the plurality of candidate probes, and the measuring machine calibration values may be respective values for calibrating the measuring machines with respect to a predetermined reference measuring machine and the probe calibration values may be respective values for calibrating the candidate probes with respect to the predetermined reference measuring machine.

In the above aspect of the invention, the measuring machine calibration values and the probe calibration values may be collectively recorded in a single storage, or alternatively, the measuring machine calibration values may be recorded in the respective measuring machines, whereas the probe calibration values may be recorded in the respective probes.

In the above aspect of the invention, the calibration values are divided into the measuring machine calibration values and the probe calibration values, which makes it possible to keep the calibration values used for the measuring machine constant by replacing the calibration values on the basis of the measuring machine calibration values when the measuring machine is changed or the like. Thus, even in a case where the measuring machine is changed, the probe calibration value of each of the candidate probes is usable without change. Alternatively, for instance, the respective probe calibration values of the candidate probes may be measured in advance using a measuring machine in a manufacturing factory, the candidate probes along with the probe calibration values may be carried to a measurement site for a user and used in a measuring machine in the measurement site. This enables a further speed-up of a measurement operation.

A measurement method according to another aspect of the invention includes: selecting a selected probe from a plurality of candidate probes and attaching the selected probe to a measuring machine; controlling the measuring machine to perform a measurement operation for a workpiece; prior to the measurement operation, recording respective calibration values of the candidate probes; and in performing the measurement operation, acquiring one of the calibration values of the candidate probes corresponding to the selected probe as a calibration value of the selected probe.

This aspect of the invention makes it possible to achieve the operations and effects as described in relation to the measuring system of the above aspect of the invention.

According to the aspects of the invention, the calibration values of the plurality of candidate probes are measured and recorded in advance in the aspect of the invention, which makes it possible to acquire the calibration value corresponding to the selected probe at the time of the measurement operation; therefore, it is not necessary to perform the calibration operation for each measurement operation and a measurement operation is allowed to be quickly performed even with the probe-interchangeable measuring machine

### BRIEF DESCRIPTION OF DRAWINGS

FIG. 1 schematically illustrates a first exemplary embodiment of the invention.

FIG. 2 is a block diagram illustrating a relevant part of the first exemplary embodiment.

FIG. 3 is a flowchart illustrating a calibration operation in the first exemplary embodiment.

FIG. 4 schematically illustrates a calibration value table in the first exemplary embodiment.

FIG. 5 is a flowchart illustrating a measurement operation in the first exemplary embodiment.

FIG. 6 is a block diagram illustrating a second exemplary embodiment of the invention.

FIG. 7 schematically illustrates a calibration value table in the second exemplary embodiment.

FIG. 8 is a block diagram illustrating a third exemplary embodiment of the invention.

### DETAILED DESCRIPTION

### First Exemplary Embodiment

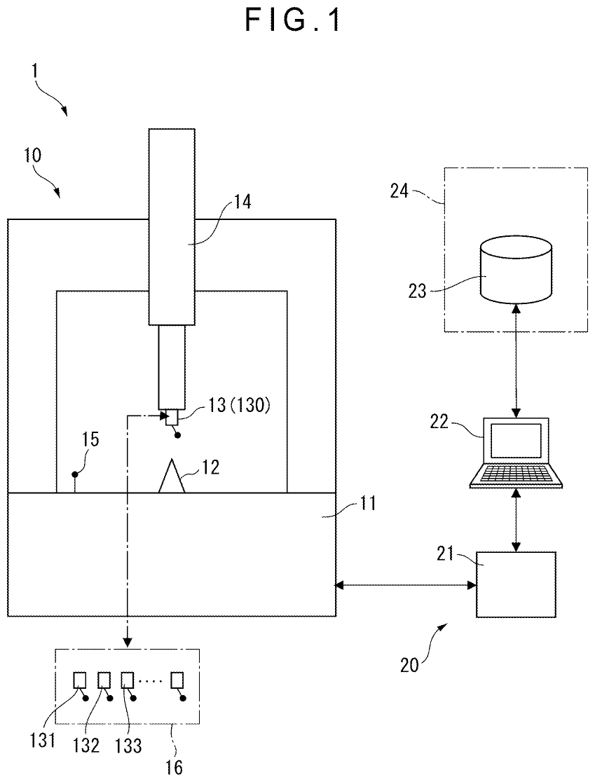

FIG. 1 to FIG. 5 each illustrate a first exemplary embodiment of the invention.

FIG. 1 illustrates a measuring system 1 based on the invention.

The measuring system 1 includes a measuring machine 10 and a control device 20 configured to control the measuring machine 10.

The measuring machine 10 is an existing coordinate measuring machine in this exemplary embodiment and a target to measure, or workpiece 12, is placed on a table 11. The measuring machine 10 includes: a motion mechanism 14 including a portal frame, and a contact probe 13 is attached to the motion mechanism 14. The measuring machine 10 causes the probe 13 attached to the motion mechanism 14 to move in three axes under the control of the control device 20 to come into contact with a surface of the workpiece 12, thereby being able to measure a three-dimensional position of the surface.

The measuring machine 10 includes a reference sphere 15 on the table 11, which is usable for a calibration operation for the probe 13.

The measuring machine 10 is an interchangeable measuring machine the probe 13 of which is replaceable. A probe storage 16 is installed as a part of or outside the measuring machine 10. A plurality of probes (for instance, candidate probes 131, 132, and 133) attachable to the measuring machine 10 are stowed in the probe storage 16. One of the candidate probes 131 to 133 (a selected probe 130) is selected and attached to the measuring machine 10.

To automatically take out and attach the selected probe 130 to the measuring machine 10, the probe storage 16 may be equipped with an automatic probe changer function and the automatic probe changer function may be controlled by the control device 20.

The control device 20 includes an operation control device 21 and a control computer 22.

The operation control device 21 performs a basic operation control of the measuring machine 10.

The control computer 22 is able to cause, in response to an operation by an operator, the measuring machine 10 to perform a measurement operation or the like via the operation control device 21 and display or output a measurement result or a state or the like of the measuring machine 10.

The control computer 22, which is connected to a network 24 through a communication line, is able to perform input/output of data from/to an external storage device 23 (a so-called storage on cloud) installed on the network 24.

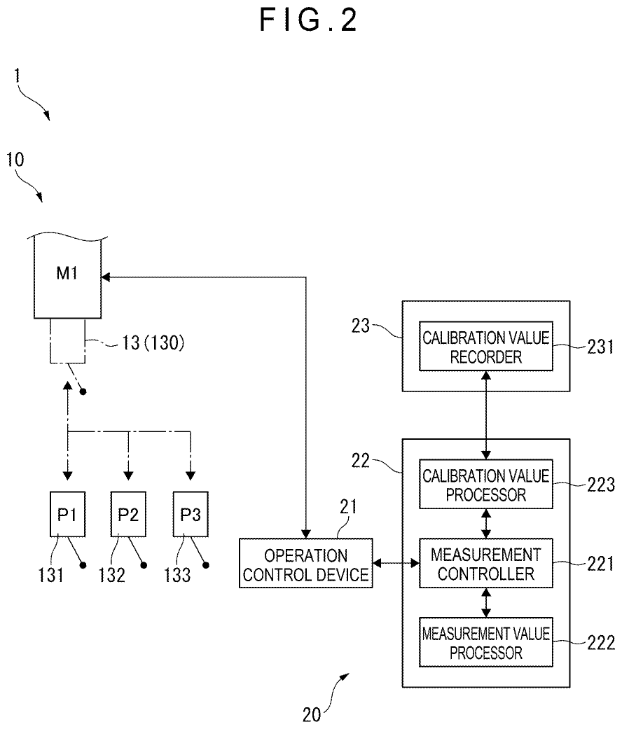

FIG. 2 illustrates details of the measuring system 1.

As described above, one selected from the candidate probes 131 to 133 is attached as the selected probe 130 to the measuring machine 10.

Probe IDs “P1”, “P2”, and “P3” for identification are assigned to the candidate probes 131, 132, and 133, respectively. A measuring machine ID “M1” for identification is assigned to the measuring machine 10.

The control computer 22 includes a measurement controller 221, a measurement value processor 222, and a calibration value processor 223. These are implemented by software executed on the control computer 22 and an input/output circuit of the control computer 22.

The measurement controller 221 controls the operation control device 21 in line with an operation program specified by an operator and causes the measuring machine 10 to perform a variety of operations including later-described calibration operation and measurement operation.

In response to the measurement operation being performed by the measuring machine 10, the measurement value processor 222 processes an obtained measurement value to display or output the measurement value.

The calibration value processor 223 records a calibration value of the probe 13 obtained through the later-described calibration operation in an external calibration value recorder 231, and reads the calibration value of the probe 13 attached for the measurement operation from the calibration value recorder 231 and sets the calibration value in the measurement controller 221.

In the exemplary embodiment, the calibration value recorder 231 is set in the storage device 23 outside the control device 20 and the storage device 23 is installed on the network 24 as described above.

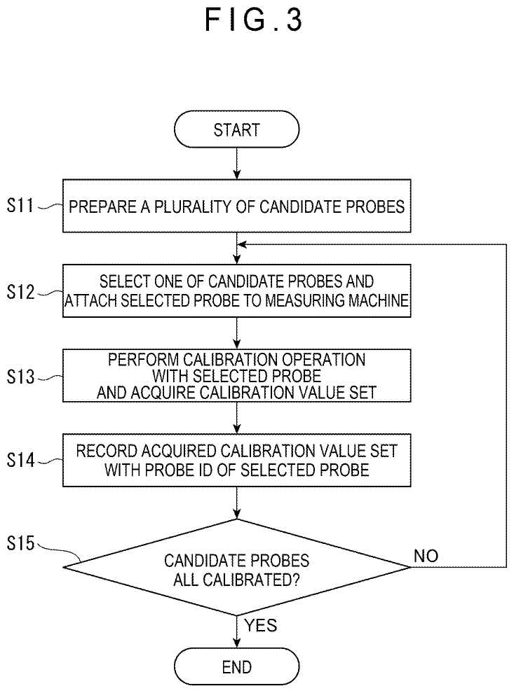

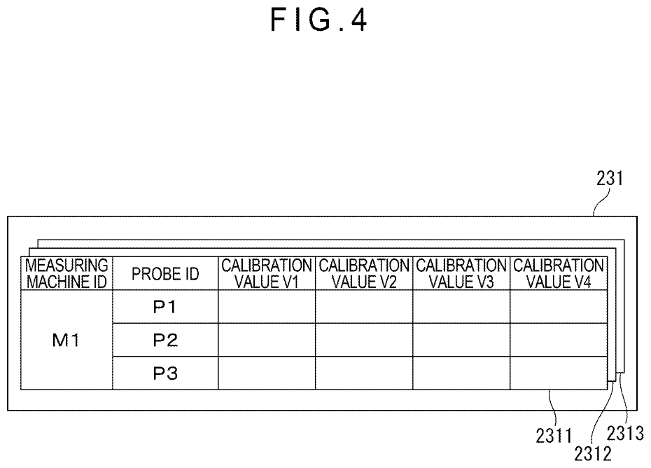

In the measuring system 1 of the exemplary embodiment, a calibration value table (see FIG. 4) is created and recorded in advance by applying the calibration operation (see FIG. 3) to the plurality of candidate probes 131 to 133 usable in the measuring machine 10.

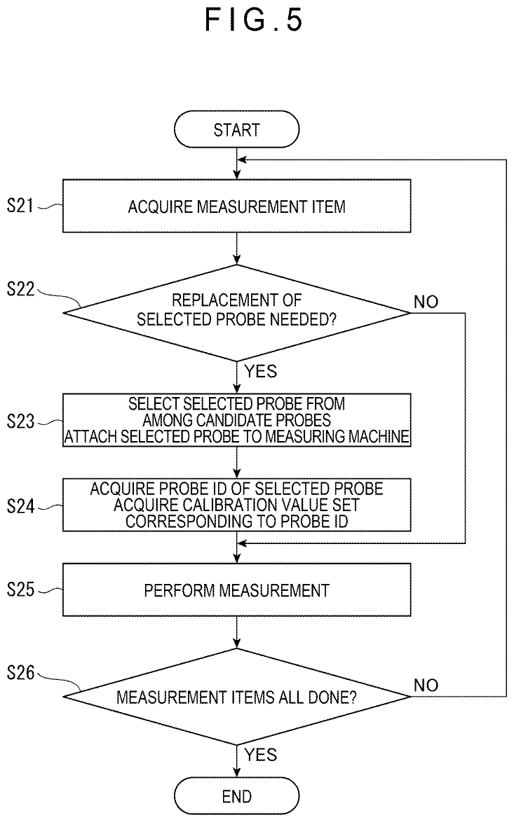

Then, during the measurement operation (see FIG. 5), the measuring machine 10 reads a corresponding calibration value from the calibration value table in replacing the selected probe 130 in the measuring machine 10, so that the calibration operation for each selected probe 130 is omitted.

FIG. 3 illustrates the calibration operation in the measuring system 1.

The calibration operation includes preparing the plurality of candidate probes 131 to 133 usable in the measuring machine 10 (Step S11) and measuring a calibration value to be applied when each of the candidate probes 131 to 133 is attached to the measuring machine 10 (Steps S12 to S15). In other words, one of the candidate probes 131 to 133 is selected and attached to the measuring machine 10 (Step S12), the calibration operation is performed with the selected probe 130 to acquire a calibration value set (Step S13), and the obtained calibration value set is recorded along with the probe ID of the selected probe 130 (Step S14). The calibration operations of all the candidate probes 131 to 133 are completed by repeating Steps S12 to S14 above.

These calibration operations are controlled by the calibration value processor 223 of the control device 20.

FIG. 4 illustrates an example of the calibration value table obtained through the calibration operation in FIG. 3.

In a calibration value table 2311, the measuring machine ID, the probe ID, and the calibration value set, i.e., calibration values V1 to V4, are located in a horizontal direction and data for each calibrated probe is located in sequence in a vertical direction.

The measuring machine ID “M1” of the measuring machine 10 that performs the calibration operation is recorded under the measuring machine ID.

The probe IDs “P1”, “P2”, and “P3” of calibrated probes are individually recorded under the probe ID.

Calibration values of the calibrated probes are individually recorded under the calibration values V1 to V4. The number of items in the calibration value set is not necessarily four and may be three or less or five or more.

The calibration values V1 to V4 are acquirable from, for instance, measurement values at a top of a surface of the reference sphere 15 mounted in the measuring machine 10 and three points on an equator of the surface.

For instance, the calibration value tables 2312, 2313 may be created by performing similar calibration operations in the different measuring machines 10. The calibration value recorder 231 may record a plurality of calibration value tables 2312, 2313 for different measuring machines 10. For instance, the calibration value tables 2312, 2313 may be created by performing similar calibration operations in the different measuring machines 10. The calibration value tables 2312, 2313 record measuring machine IDs “M2”, “M3” identifying the measuring machines 10 that perform the calibration operations, respectively.

These calibration value tables 2311 to 2313 are individually created by the calibration value processor 223 and collectively recorded in the calibration value recorder 231.

FIG. 5 illustrates the measurement operation in the measuring system 1.

The measurement operation includes setting the operation program in which a measurement content for the workpiece 12 is specified in the control device 20 and causing the measuring machine 10 to operate under the control of the measurement controller 221.

The measurement controller 221 acquires a measurement item from the operation program (Step S21) and determines whether the replacement of the selected probe 130 is required (Step S22).

In a case where the selected probe 130 specified by the measurement item is the selected probe 130 currently attached to the measuring machine 10, the process proceeds to the execution of measurement (Step S25).

In a case where the selected probe 130 selected by the measurement item is different from the selected probe 130 currently attached to the measuring machine 10, the selected probe 130 is to be replaced.

In replacing the selected probe 130, after the current selected probe 130 is removed from the measuring machine 10, one of the plurality of candidate probes 131 to 133 specified by the measurement item is selected and attached as a next selected probe 130 to the measuring machine 10 under the control of the measurement controller 221 (Step S23).

Further, the measurement controller 221 acquires the probe ID of the next selected probe 130 and acquires the calibration value set of the selected probe 130 from the calibration value recorder 231 via the calibration value processor 223 (Step S24).

Specifically, the measurement controller 221 selects one of the calibration value tables 2311 to 2313 (see FIG. 4) with reference to the measuring machine ID of the measuring machine 10 and reads the calibration values V1 to V4 corresponding to the probe ID (P1 to P3) of the selected probe 130.

The read calibration values V1 to V4 are returned to the measurement controller 221 and reflected in the operation control of the measuring machine 10 as the calibration values of the current selected probe 130.

After the replacement of the selected probe 130 (Steps S23 to S24), the measuring machine 10 performs measurement according to the measurement item under the control of the measurement controller 221 (Step S25).

The measurement controller 221 determines the operation program (Step S26) and repeats Steps S21 to S25 in a case where any measurement item is unprocessed or terminates the measurement operation based on the operation program in a case where all the measurement items are processed.

As described above, the measuring system 1 includes the measuring machine 10, the plurality of candidate probes 131, 132, 133 attachable to the measuring machine 10, the selected probe 130 selected from the candidate probes 131, 132, 133 and attached to the measuring machine 10, and the control device 20 configured to control the measuring machine 10 to perform the measurement operation for a workpiece.

Moreover, the control device 20 includes the calibration value recorder 231 configured to record respective calibration values of the candidate probes 131, 132, 133 with respect to the measuring machine 10 and the calibration value processor 223 configured to acquire one of the calibration values corresponding to the selected probe 130 from the calibration value recorder 231.

Moreover, in the exemplary embodiment, a measurement method includes: selecting the selected probe 130 from the plurality of candidate probes 131 to 133 and attaching the selected probe 130 to the measuring machine 10; controlling the measuring machine 10 to perform the measurement operation for the workpiece 12; prior to the measurement operation, recording respective calibration values of the candidate probes 131 to 133; and in performing the measurement operation, acquiring one of respective calibration values of the candidate probes 131 to 133 corresponding to the selected probe 130 as a calibration value of the selected probe 130.

The exemplary embodiment as described above produces the following effects.

In the exemplary embodiment, prior to the measurement operation, the calibration operation (see FIG. 3) is performed for each of the plurality of candidate probes 131 to 133 to measure a calibration value that is to be applied when the probe is attached to the measuring machine 10 and the calibration value is recorded in the calibration value recorder 231 (see FIG. 4). For the measurement operation, a suitable probe for the measurement of the workpiece 12 is selected as the selected probe 130 from the plurality of candidate probes 131 to 133 and is attached to the measuring machine 10. In the control device 20, the calibration value corresponding to the selected probe 130 is read from the calibration value recorder 231 by the calibration value processor 223 and used as the calibration value of the selected probe 130 for the measurement operation.

As seen from the above, the calibration values of the plurality of candidate probes 131 to 133 are measured and recorded in advance in the exemplary embodiment, which makes it possible to acquire the calibration value corresponding to the selected probe 130 at the time of the measurement operation; therefore, it is not necessary to perform the calibration operation for each measurement operation and a measurement operation is allowed to be quickly performed even with the probe-interchangeable measuring machine 10.

In the exemplary embodiment, the calibration value recorder 231 is installed in the external storage device 23 that is able to communicate with the control device 20, which eliminates the necessity for machining or the like of the candidate probes 131 to 133 and the measuring machine 10. Further, it is possible to collectively record the calibration values of the plurality of candidate probes 131 to 133 in the calibration value recorder 231, which facilitates a maintenance work such as data backup. In particular, in a case where the calibration value recorder 231 is set in the storage device 23 outside the control device 20, it is possible to still use the calibration value recorder 231 on an external recording region even when the control device 20 is changed.

### Second Exemplary Embodiment

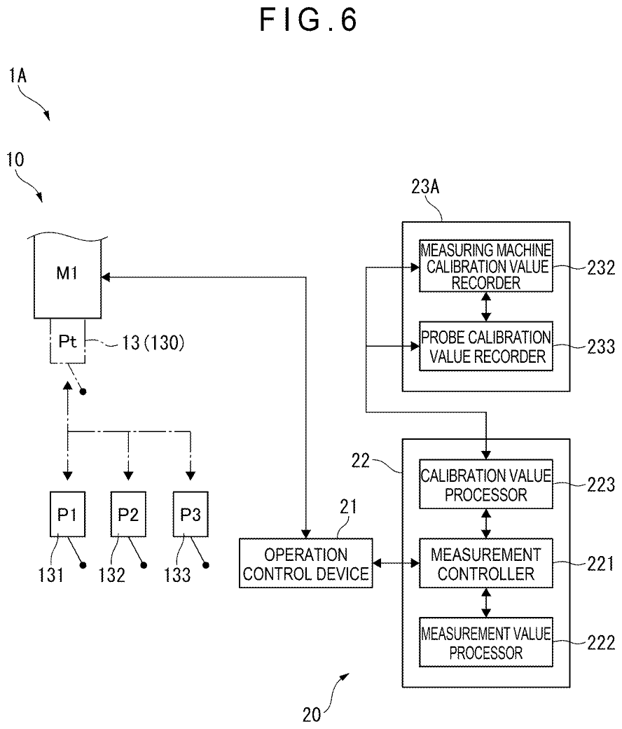

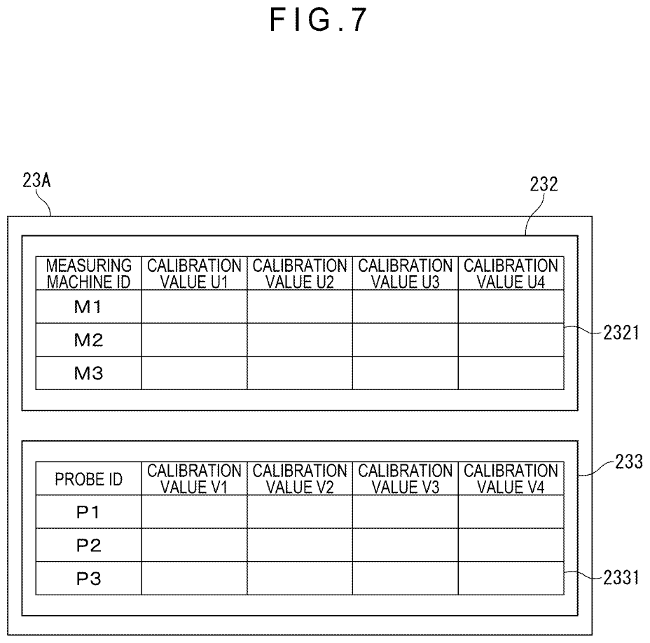

FIG. 6 to FIG. 7 each illustrate a second exemplary embodiment of the invention.

In FIG. 6, a basic configuration of a measuring system 1A of the exemplary embodiment is similar to that of the above first exemplary embodiment. Accordingly, the same reference numeral is used to refer to a common component to omit a redundant description and a difference will be described below.

In the first exemplary embodiment described above, the calibration value recorder 231 is set in the storage device 23 outside the control device 20 and the respective calibration value tables 2311 to 2313 for the measuring machines 10 are recorded in the calibration value recorder 231. Moreover, with respect to the plurality of measuring machines 10, respectively, the calibration value tables 2311 to 2313 record calibration values obtained by calibrating the plurality of candidate probes 131 to 133.

In this regard, however, in the second exemplary embodiment, two calibration value recorders, namely, a measuring machine calibration value recorder 232 and a probe calibration value recorder 233, are set in a storage device 23A outside the control device 20.

In FIG. 7, the measuring machine calibration value recorder 232 and the probe calibration value recorder 233 are set in the storage device 23A.

A measuring machine calibration value table 2321 is recorded in the measuring machine calibration value recorder 232 and a probe calibration value table 2331 is recorded in the probe calibration value recorder 233.

In the measuring machine calibration value table 2321, calibration values U1 to U4 of each measuring machine ID are recorded. The calibration values U1 to U4 of each measuring machine ID are calibration values obtained by calibrating, with the assumption that one of the measuring machines 10 (for instance, a measuring machine “M1”) is a reference measuring machine, another one of the measuring machines 10 (for instance, a measuring machines “M2”, “M3”) with respect to the reference measuring machine. Thus, in performing the operation control for, for instance, the measuring machine “M2”, it is possible to simulate the operation control for the measuring machine “M1” with reference to the calibration values U1 to U4 of the measuring machine ID “M2.”

The number of the calibration values U1 to U4 is not necessarily four and may be three or less or five or more. The reference measuring machine is not necessarily the actual measuring machine 10 such as the measuring machine “M1” but an imaginary measuring machine may be set and defined as the reference measuring machine.

In the probe calibration value table 2331, calibration values V1 to V4 of each probe ID are recorded. The calibration values V1 to V4 of each probe ID are created by performing the calibration operations (see FIG. 3) for the plurality of candidate probes 131 to 133 in the reference measuring machine (for instance, the measuring machine “M1”) defined as the reference for the creation of the above measuring machine calibration value table 2321. Thus, the probe calibration value table 2331 is similar to the calibration value tables 2311 to 2313 of the above first exemplary embodiment, except that the item regarding the measuring machine ID is removed.

The probe calibration value table 2331 may record the measuring machine ID identifying the reference measuring machine that is a target of calibration, which is allowed to be referred to in selecting the calibration values U1 to U4 in the measuring machine calibration value table 2321.

These measuring machine calibration value table 2321 and the probe calibration value table 2331 are individually created by the calibration value processor 223 and recorded in the measuring machine calibration value recorder 232 and the probe calibration value recorder 233.

In the exemplary embodiment as described above, when the measuring machine 10 is, for instance, the measuring machine “M2”, the calibration values U1 to U4 corresponding to the measuring machine ID “M2” in the measuring machine calibration value table 2321 are read into the control device 20 from the measuring machine calibration value recorder 232. Then, in a case where “P1” is used as the selected probe 130 for the measurement operation, the calibration values V1 to V4 corresponding to the probe ID “P1” in the probe calibration value table 2331 are read into the control device 20 from the probe calibration value recorder 233.

As a result, in the control device 20, the reference measuring machine “M1” is simulated by virtue of the calibration values U1 to U4 corresponding to the measuring machine ID “M2” even though the measuring machine 10 is “M2” and a correctly calibrated measurement operation is performed with the calibration values with respect to the reference measuring machine “M1”, that is, the calibration values V1 to V4 corresponding to the probe ID “P1.”

As seen from the above, a combination of the measuring machine calibration values U1 to U4 of the individual measuring machines 10 with respect to the reference measuring machine and the probe calibration values V1 to V4 of each of the candidate probes 131 to 133 with respect to the reference measuring machine makes it possible to provide the calibration values of each of the candidate probes 131 to 133 with respect to each of the measuring machines 10.

In the exemplary embodiment as described above, the calibration values are divided into the measuring machine calibration values (the calibration values U1 to U4 recorded in the measuring machine calibration value table 2321) and the probe calibration values (the calibration values V1 to V4 recorded in the probe calibration value table 2331), which makes it possible to keep the calibration values used for the measuring machine constant by replacing the calibration values on the basis of the measuring machine calibration values when the measuring machine 10 is changed or the like.

Thus, even in a case where the measuring machine 10 is changed, the probe calibration values (the calibration values V1 to V4) of each of the candidate probes 131 to 133 are usable without change.

Alternatively, for instance, the respective probe calibration values of the candidate probes 131 to 133 may be measured in advance using a measuring machine 10 in a manufacturing factory, the candidate probes 131 to 133 along with the probe calibration values thereof (the probe calibration value table 2331) may be carried to a measurement site for a user and used in a measuring machine 10 in the measurement site. This enables a further speed-up of a measurement operation.

### Third Exemplary Embodiment

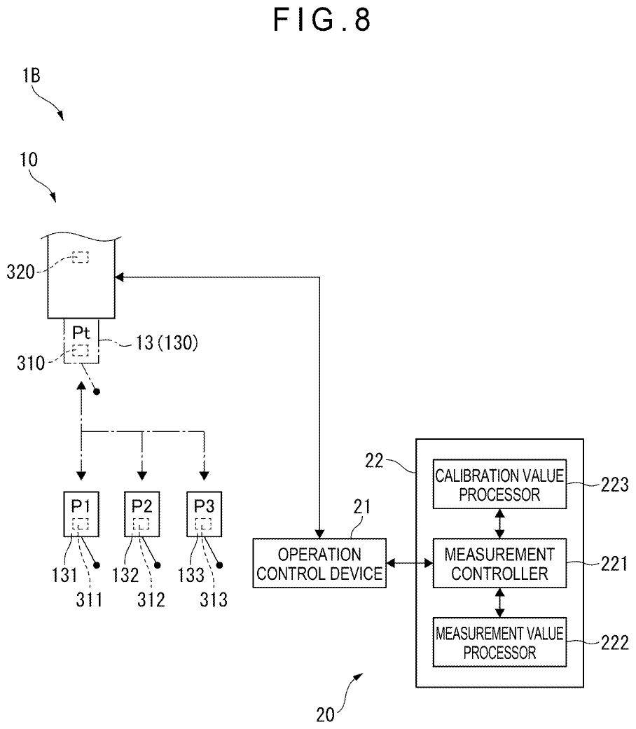

FIG. 8 illustrates a third exemplary embodiment of the invention.

In FIG. 8, a basic configuration of a measuring system 1B of the third exemplary embodiment is similar to that of the above first exemplary embodiment. Accordingly, the same reference numeral is used to refer to a common component to omit a redundant description and a difference will be described below.

In the first exemplary embodiment described above, the calibration value recorder 231 is set in the storage device 23 outside the control device 20 and the respective calibration value tables 2311 to 2313 for the measuring machines 10 are recorded in the calibration value recorder 231. Moreover, with respect to the plurality of measuring machines 10, respectively, the calibration value tables 2311 to 2313 record calibration values obtained by calibrating the plurality of candidate probes 131 to 133.

In this regard, however, in the second exemplary embodiment described above, two calibration value recorders, namely, a measuring machine calibration value recorder 232 and a probe calibration value recorder 233, are set in a storage device 23A outside the control device 20 in place of the storage device 23 of the first exemplary embodiment. The measuring machine calibration value table 2321 is recorded in the measuring machine calibration value recorder 232 and the probe calibration value table 2331 is recorded in the probe calibration value recorder 233.

As compared with the first exemplary embodiment and the second exemplary embodiment as described above, the storage devices 23, 23A are omitted in the third exemplary embodiment. Moreover, the calibration values U1 to U4 of each measuring machine ID described in the second exemplary embodiment are recorded in the measuring machine 10 and the calibration values V1 to V4 of each probe ID are recorded in each of the candidate probes 131 to 133.

The measuring machine 10 includes a measuring machine calibration value recorder 320, which is set in a storage region within the device.

The measuring machine calibration value recorder 320 records the calibration values U1 to U4 of the measuring machine 10 with respect to a predetermined reference measuring machine. The calibration values U1 to U4 correspond to the calibration values U1 to U4 of one of the measuring machine IDs (for instance, the calibration values U1 to U4 of the measuring machine ID “M2”) in the measuring machine calibration value table 2321 of the second exemplary embodiment.

The candidate probes 131 to 133 include probe calibration value recorders 311, 312, 313, respectively, which are set in the storage regions in the devices.

The probe calibration value recorders 311, 312, 313 each record the calibration values V1 to V4 of the corresponding one of the candidate probes 131 to 133 with respect to the predetermined reference measuring machine. The calibration values V1 to V4 correspond to the calibration values V1 to V4 of one of the probe IDs (for instance, the calibration values V1 to V4 of the probe ID “P1”) in the probe calibration value table 2331 of the second exemplary embodiment.

The control device 20 is able to acquire the calibration values U1 to U4 recorded in the measuring machine calibration value recorder 320 by communicating with the measuring machine 10 via the operation control device 21.

Additionally, in response to one of the candidate probes 131 to 133 being attached as the selected probe 130 to the measuring machine 10, the control device 20 is able to acquire the calibration values V1 to V4 recorded in the probe calibration value recorder 310 of the selected probe 130 (corresponding to one of the probe calibration value recorders 311 to 313 of the candidate probes 131 to 133).

As a means for reading from the probe calibration value recorder 310 of the selected probe 130, the measuring machine 10 may be equipped with a wire or wireless communication function.

In the exemplary embodiment as described above, the calibration values U1 to U4 of the measuring machine 10 with respect to the reference measuring machine and the calibration values V1 to V4 of each of the candidate probes 131 to 133 with respect to the reference measuring machine are acquired and a combination of these calibration values makes it possible to provide the calibration values of each of the candidate probes 131 to 133 with respect to the measuring machine 10. This is able to produce effects similar to that of the second exemplary embodiment.

Further, the calibration values V1 to V4 of the selected probe 130 are caused to accompany one of the candidate probes 131 to 133 selected as the selected probe 130, which makes it possible to secure the correspondence between the calibration values V1 to V4 and the candidate probes 131 to 133.

Additionally, the calibration values V1 to V4 of the selected probe 130 are recorded calibration values with respect to the reference measuring machine, and calibration of each measuring machine 10 is achievable by virtue of the calibration values U1 to U4 of the measuring machine 10 accompanying the measuring machine 10. Accordingly, values of calibration performed with another measuring machine 10 are usable as the calibration values V1 to V4 of the selected probe 130.

### OTHER EXEMPLARY EMBODIMENTS

It should be noted that the invention is not limited to the above exemplary embodiments and modifications and the like are within the scope of the invention as long as the object of the invention is achievable.

In the above exemplary embodiments, the three candidate probes 131 to 133 are provided by way of example but the number of the candidate probes may be two or four or more. Additionally, the four calibration values V1 to V4 or calibration values U1 to U4 are provided as the calibration value set by way of example but the number of the items may be three or less or five or more.

In the above exemplary embodiments, the storage devices 23, 23A outside the control device 20, the storage region of the measuring machine 10 (the measuring machine calibration value recorder 320), and the recording region/regions of the selected probe 130 or the candidate probes 131 to 133 (the probe calibration value recorders 310, 311 to 313) are used as the locations of the calibration value recorders. In this regard, however, a recording region within the control device 20, for instance, a storage region of the control computer 22 or a recording region of the operation control device 21, may be used. Further, the calibration value processor 223 is not necessarily in the form of software in the control computer 22 but may be incorporated in the operation control device 21.

In the above exemplary embodiments, the reference sphere 15 of the measuring machine 10 is used for the calibration operation but any other means able to acquire the calibration values V1 to V4 of the selected probe 130 or the like may be used. Additionally, the calibration value set of the probe does not necessarily include the four calibration values V1 to V4 but it is sufficient that the required number of values for the measuring systems 1, 1A, 1B are prepared.

What is claimed is:

1. A measuring system comprising:
a measuring machine;
a plurality of candidate probes attachable to the measuring machine;
a selected probe selected from the candidate probes and attached to the measuring machine; and
a control device configured to control the measuring machine to perform a measurement operation for a workpiece,
the control device comprising:
a calibration value recorder configured to record respective calibration values of the candidate probes with respect to the measuring machine; and
a calibration value processor configured to acquire one of the calibration values corresponding to the selected probe from the calibration value recorder.

2. The measuring system according to claim 1, wherein the calibration value recorder is located in an internal storage device of the control device or an external storage device that is connected to the control device and is able to communicate with the control device, the calibration value recorder recording the respective calibration values corresponding to the plurality of candidate probes.

3. The measuring system according to claim 1, wherein the calibration value recorder is located in each of the candidate probes, the calibration value recorder recording the calibration value of each of the candidate probes.

4. The measuring system according to claim 1, wherein the calibration values are acquired using a reference sphere mounted in the measuring machine.

5. The measuring system according to claim 1, wherein
the calibration values are values given by a calculation from respective measuring machine calibration values set for a plurality of measuring machines including the measuring machine and respective probe calibration values set for the plurality of candidate probes, and
the measuring machine calibration values are respective values for calibrating the measuring machines with respect to a predetermined reference measuring machine and the probe calibration values are respective values for calibrating the candidate probes with respect to the predetermined reference measuring machine.

6. A measurement method comprising:
selecting a selected probe from a plurality of candidate probes and attaching the selected probe to a measuring machine;
controlling the measuring machine to perform a measurement operation for a workpiece;
prior to the measurement operation, recording respective calibration values of the candidate probes; and
in performing the measurement operation, acquiring one of the calibration values of the candidate probes corresponding to the selected probe as a calibration value of the selected probe.
